(19) United States
(12) Patent Application Publication
(10) Pub. No.: US 2021/0185461 A1
(43) Pub. Date: Jun. 17, 2021

(54) CIRCUIT BOARD OF A HEARING AID, HEARING AID AND METHOD OF MANUFACTURING THE CIRCUIT BOARD

(71) Applicant: SIVANTOS PTE. LTD., Singapore (SG)

(72) Inventors: CHRISTOPH GRABOWSKI, NUERNBERG (DE); ANDREAS PFROMMER, ERLANGEN (DE); LUKAS BERKELMANN, HANNOVER (DE); DIRK MANTEUFFEL, MEERBUSCH (DE)

(21) Appl. No.: 17/120,513

(22) Filed: Dec. 14, 2020

(30) Foreign Application Priority Data
Dec. 12, 2019 (DE) 10 2019 219 484.2

(51) Int. Cl. H04R 25/00

(52) U.S. Cl. CPC H04R 25/609; H04R 25/602; H04R 25/554; H04R 25/604

(57) ABSTRACT

A circuit board of a hearing aid, in particular of a hearing aid device, has a base body to which a first electrical component and a second electrical component are bonded, more specifically are directly electrically connected by means of a conductive track. An electrically conductive, continuous antenna surface, as well as a communications receiver that is electrically connected at two different feed points to the antenna surface, are bonded to the base body. The antenna surface is partially opened between the feed points. A method describes the steps for manufacturing the circuit board and to a hearing aid having the circuit board.

### CROSS-REFERENCE TO RELATED APPLICATION

This application claims the priority, under 35 U.S.C. § 119, of German patent application DE 10 2019 219 484, filed Dec. 12, 2019; the prior application is herewith incorporated by reference in its entirety.

### BACKGROUND OF THE INVENTION

### Field of the Invention

The invention relates to a circuit board of a hearing aid, a method for the manufacture of a circuit board of a hearing aid, and to a hearing aid. The hearing aid is here in particular a hearing aid device.

Persons who suffer from an impairment of the hearing capacity usually use a hearing aid device. An ambient sound is in most cases captured here by means of an electromechanical sound transducer. The electrical signals that are captured are processed by an amplifier circuit and introduced into the auditory canal of the person by means of a further electromechanical transducer. The sound signals that have been captured are in most cases also processed, for which a signal processor of the amplifier circuit is usually used. The amplification is matched here to the hearing loss that the wearer of the hearing aid may have.

Different types of hearing aid device are known. What are known as “behind-the-ear-devices” are worn between the skull and the ear muscle. The introduction of the amplified signal into the auditory canal takes place here by means of a sound tube. A further common variation of a hearing aid device is an “in-the-ear-device”, in which the hearing aid device itself is introduced into the auditory canal. The auditory canal is consequently at least partially closed by means of this hearing aid device, so that apart from the sound signals generated by means of the hearing aid device, no other sound—or only a greatly reduced quantity—can penetrate to the auditory canal.

Hearing aid devices in most cases also comprise a communications apparatus, so that data transmission to the hearing aid device is possible. It is thus, for example, possible to use an external microphone or, for example, to transmit configuration data from an external device such as a mobile telephone. The communications apparatus contains a communications receiver to which an antenna is connected through signal technology. Radio waves received by means of the antenna are acquired by means of the communications receiver. The antenna is excited by means of the communications receiver in order to transmit corresponding radio waves.

Since relatively little installation space is available in a hearing aid device, all or at least many components are in most cases disposed on a common circuit board. The communications apparatus is thus also fastened to a common circuit board along with further components. The further components are connected to one another by means of conductive tracks. If operation of the communications apparatus now occurs, i.e. in particular if the antenna is excited by the communications receiver, or corresponding signals are received by the antenna, these radio waves also radiate to the further components and the conductive tracks. These also work in the manner of an antenna, and are excited by means of the radio waves. Excitations brought about as a result of the radio waves are therefore introduced into the data exchanged between the components by means of the conductive track. If these are now also operated on the basis of electrical signals, and in particular are connected to one another through signal technology, they are disrupted.

Providing a choke between components connected through signal technology in this way is therefore known from published, European patent application EP 2 835 863 A1, corresponding to U.S. Pat. Nos. 10,779,095, 10,555,097, 10,306,382, 10,136,230, 9,961,457 and 9,680,209. Interference introduced into the conductive tracks by means of the radio waves is suppressed by means of the chokes, so that undisrupted operation continues to be possible. In addition, the chokes ensure that the conductive tracks do not short-circuit the antenna at the excitation points through capacitive coupling.

### BRIEF SUMMARY OF THE INVENTION

The invention is based on the object of providing a particularly suitable circuit board of a hearing aid, a particularly suitable method for the manufacture of a circuit board of a hearing aid, as well as a particularly suitable hearing aid, wherein, in particular, manufacturing costs and/or installation space are reduced.

For the circuit board, this object is achieved according to the invention through the features of the independent circuit board claim, for the method through the features of the independent method claim, and for the hearing aid through the features of the independent hearing aid claim. Advantageous developments and elaborations are the object of the respective subsidiary claims.

The circuit board is an element of a hearing aid. The hearing aid is, for example, an earpiece set, or comprises an earpiece set. Particularly preferably, however, the hearing aid is a hearing aid device. The hearing aid device serves to assist a person suffering from a reduction of hearing capacity. In other words, the hearing aid device is a medical device, by means of which, for example, a partial hearing loss is compensated for. The hearing aid device is, for example, a “receiver-in-the-canal” hearing aid device (RIC), an in-ear or “in-the-ear” hearing aid device, an “in-the-canal” hearing aid device (ITC) or a “complete-in-canal” hearing aid device (CIC), hearing spectacles, a pocket hearing aid device, a bone-conduction hearing aid device or an implant. Particularly preferably the hearing aid device is a behind-the-ear hearing aid device that is worn behind an ear muscle.

The hearing aid is provided and configured to be carried at the human body. In other words, the hearing aid preferably comprises a holding device by means of which fastening to the human body as possible. Inasmuch as the hearing aid is a hearing aid device, the hearing aid is provided and configured to be disposed, for example, behind the ear or inside an auditory canal. The hearing aid is in particular wireless, and is provided and configured to be introduced at least partially into an auditory canal. The hearing aid particularly preferably comprises an energy store by means of which a supply of energy is made available.

The circuit board contains a base body that is, for example, designed in the form of a board. The base body here is in particular manufactured of a glass-fiber-reinforced epoxy resin. As an alternative to this, the base body is, for example, designed to be flexible, and is in particular a foil. The base body preferably contains a number of conductive tracks that are manufactured, for example, from copper or another electrically conductive material, preferably a metal. The circuit board further contains a first electrical component and a second electrical component that are bonded to the base body. A specific function is in particular here fulfilled by each of the electrical components. Each of these electrical components contains, for example, a number of electrical and/or electronic components that are connected to one another in a suitable manner to form a common circuit. Each of the electrical components is expediently a separate component that is manufactured independently of the base body and is bonded to it for assembly and expediently makes electrical contact with it. The electrical components are, for example, bonded to the base body by means of a THT method or an SMD method, and thus electrically contacted with it.

The two electrical components are furthermore directly connected to each other electrically by means of the conductive track or one of the conductive tracks. The conductive track is, for example, an element of the base body or is fastened to it. The conductive tracks are in particular made of copper. The two electrical components are directly electrically connected to one another. In other words, there is no further component located between them, by which data exchanged between the two electrical components by means of the conductive track is affected.

Preferably these two electrical components are directly electrically connected to one another, and thereby connected in terms of signal technology, by means of a plurality of such conductive tracks, so that a speed of data transmission between them is increased. Preferably the circuit board contains further electrical components that are connected through signal technology by means of one of the conductive tracks in each case to the first electrical component, the second electrical component, and/or to one another.

The circuit board further contains an electrically conductive, continuous antenna surface. The antenna surface here forms an antenna and is, for example, manufactured from copper. The antenna surface is, in particular, manufactured in one working step with the manufacture of the conductive track and in the same manner as the conductive track, for example by means of etching. The antenna surface thus does not have elements that are separate from one another, but these are connected to one another in a low-resistance manner, and there is no electrical isolation. It is thus possible that, for example, the antenna surface contains a plurality of sections that are, however, directly electrically contacted, for example by means of a conductive track or an appropriately shaped further section. The antenna surface serves in particular as an antenna. Particularly preferably a ground surface of the circuit board is utilized as an antenna surface. The electrical potential of ground is made available for all, or at least a part, of the components attached to the base body by means of the ground surface.

In addition, the circuit board contains a communications receiver, in other words in particular what is known as a transceiver. The communications receiver is here electrically connected to the antenna surface at two different feed points, so that a communications apparatus in particular is realized. It is possible here to transmit and/or to receive signals by means of the communications apparatus. The communications receiver as well as the antenna surface are here in particular suitable, in particular provided and configured, for the transmission of electromagnetic waves that in particular represent signals, in particular into what is known as a far field. In other words, a transmission/reception of radio waves takes place. In summary, it is possible to excite the antenna surface or to acquire an excitation of the antenna surface, by means of the communications receiver, for which purpose each of the feed points is used. A corresponding electrical current flow occurs here through the feed points, or a different electrical potential is present at them.

The antenna surface is partially opened between the feed points. The antenna surface has, in other words, an opening that is, for example, fabricated at an edge of the antenna surface, so that the opening is open. As an alternative to this, the opening is introduced essentially centrally or in a central region of the antenna surface, so that the opening has the form of a hole. The shape of the opening is, for example, round or rectangular, which simplifies manufacture. In one further development there is, for example, a plurality of such openings. The opening here is always located spatially between the feed points.

The matching behavior of the antenna surface is changed because of the opening in the antenna surface. Due to the opening it is possible to feed the antenna surface using an appropriate transmitter-receiver impedance. In particular it is also not necessary that the antenna surface is electrically disconnected from the communications receiver. No additional inductors are therefore required in any data lines that may be located between the feed points and the communications receiver. It is in particular not necessary to use a particular filter or the like that is introduced in terms of signal technology into the conductive track and/or the data lines and/or that is connected upstream in terms of signal technology of one of the electrical components. Fewer components are consequently required, which reduces installation space. Manufacturing costs are also reduced in this way.

The communications receiver is appropriately connected in terms of signal technology to at least one of the electrical components, preferably by means of a conductive track. It is thus possible to forward signals received by means of the communications receiver to the electrical components, or to make signals generated by means of the electrical components available to further devices via the antenna surface.

The antenna surface and the conductive track are for example disposed on the same side of the base body. In particular in this case only one side of the base body is fitted with components, which simplifies manufacture. The antenna surface and the conductive track are, however, particularly preferably disposed on opposite sides of the base body. Expediently here the two electrical components are located on the side of the conductive track, and the communications receiver is located on the side of the antenna surface. The communications receiver is appropriately connected in terms of signal technology to one of the electrical components, for example by means of a through-contact. The spatial extent required by the base body is reduced as a result of arranging the circuit tracks and the antenna surface on opposite sides of the base body, so that installation size is reduced. An electrical insulation of the conductive track from the antenna surface is also provided in this way.

The first component is, in particular, an electromechanical sound transducer, by means of which an ambient sound can be acquired. This electromechanical sound transducer thus serves as a microphone. In particular, the first electrical component contains a plurality of such microphones, so that a specific directional effect can be achieved. The hearing aid appropriately contains a further electromechanical sound transducer, by means of which sound is output. In particular, this electromechanical sound transducer acts as a loudspeaker.

As an alternative, or particularly preferred in combination with this, the second electrical component is a signal processor that is appropriately connected in terms of signal technology between the first electrical component and the sound transducer acting as a loudspeaker. The signal processor is, for example, a digital signal processor (DSP) or is realized by means of an analogue circuit. By means of the signal processor, an adaptation takes place in particular of a signal that is fed in, in particular generated with the first electrical component. The first electrical component expediently contains an ND converter, assuming that the signal processor is designed as a digital signal processor. The communications receiver is appropriately also connected in terms of signal technology to the second electrical component, so that signals that were received by means of the communications receiver can be output by means of the loudspeaker that may be present.

The antenna surface and the communications receiver are preferably configured for the transmission and reception of electromagnetic waves in a first frequency band. There is thus both an upper and a lower limit of the first frequency band. The lower limit of the first frequency band is expediently greater than or equal to 10 MHz, 100 MHz or 1 GHz. Preferably the upper limit of the first frequency band is smaller than or equal to 100 GHz, or smaller than or equal to 10 GHz. As a result of a first frequency band of this sort, it is possible to exchange the electromagnetic waves over a comparatively large distance. A bandwidth is also increased.

The first electrical component and the second electrical component are preferably configured, i.e. are suitable as well as provided and designed, for the mutual exchange of electrical signals. The exchange of the electrical signals preferably takes place via the conductive track or the plurality of conductive tracks if the two electrical components are connected to one another electrically by means of a plurality of conductive tracks, and are thus connected in terms of signal technology. The exchange of the signals takes place in a second frequency band. In other words, a clocked transmission of the signals takes place between the two electrical components in particular, which simplifies a configuration as well as a control. The exchange of the electrical signals preferably takes place in a second frequency band. In other words, there is both an upper and a lower limit of the second frequency band. The lower limit of the second frequency band is, for example, greater than or equal to 1 kHz, 10 kHz or 100 kHz. Preferably the upper limit of the second frequency band is smaller than or equal to 100 MHz, 50 MHz, or 1 MHz. The first and the second frequency bands are particularly preferably different. As a result of this, an interaction between the respective signals, and therefore also in the operation of the antenna surface and of the conductive track and the respective components connected to it, is further reduced.

The method serves for the manufacture of a circuit board of a hearing aid that is, in particular, a hearing aid device. In the manufactured state, the circuit board here contains a base body to which a first electrical component and a second electrical component are bonded, that are directly electrically connected by means of a conductive track. An electrically conductive, continuous antenna surface, as well as a communications receiver that is electrically connected at two different feed points to the antenna surface, are also bonded to the base body. The antenna surface is partially opened between the feed points. The antenna surface and the communications receiver are configured here for the transmission and reception of electromagnetic waves in a first frequency band, i.e. are suitable as well as provided and configured. The first electrical component and the second electrical component are configured for the exchange of electrical signals in a second frequency band. The first and the second frequency bands differ here.

The method now provides that the antenna surface is excited in the first frequency band. In this state, the antenna surface preferably does not yet have an opening. The excitation takes place electrically. For example, a particular electrical voltage is applied here to the antenna surface, or a particular electrical current is guided through it. Preferably here the communications receiver is already connected to the antenna surface at the feed points, so that the excitation of the antenna surface takes place by means thereof. The hardware requirement is thereby reduced. Following this, the resulting current distribution in the antenna surface is determined. The antenna surface is opened depending on the current distribution. In other words, the introduction of the openings in the antenna surface is made depending on the resulting current distribution when the antenna surface is excited in the first frequency band. Provided the feed points are already present, the opening is expediently introduced between the two feed points. The characteristic impedance of the antenna surface is adjusted as a result of the introduction of the opening. The adjustment here is expediently made to the communications receiver, so that the characteristic impedance of the antenna surface appropriately matches the impedance of the communications receiver.

The antenna surface is, for example actually physically excited, and the current distribution is acquired by means of an appropriate sensor. Particularly preferably, however, a simulation program is employed for both the working steps. In particular, a numerical simulation program is employed for this purpose, by means of which a characteristic mode analysis of the antenna surface is thus performed. In other words, in the method the characteristic modes of the antenna surface are thus ascertained, and the antenna surface is opened to adjust the characteristic impedance depending on the resulting current distribution of the modes to be excited.

Preferably the method is only carried out when manufacturing the first circuit board of a series of circuit boards, or when designing the circuit board. Once the position and the shape of the openings are determined, this shape and this position of the opening is expediently also used for subsequent circuit boards, without an excitation of the antenna surface taking place each time. A manufacturing process is thus shortened. As an alternative to this, the antenna surface is excited, and the opening that is adjusted to this is created with each circuit board. Manufacturing tolerances are in this way also taken into consideration, which increases reliability.

The antenna surface has, for example, no opening at the beginning of the method. As an alternative to this, the method has already, for example, been carried out, and is subsequently carried out here once again. In other words, the antenna surface is electrically excited in the first frequency band a plurality of times in sequence, wherein an opening is subsequently first made in the antenna surface depending on the current distribution resulting in each case. The antenna surface thus has a plurality of openings that are, for example, spaced apart from one another or which merge into one another.

Preferably in the method the base body is first provided, to which the first electrical component and the second electrical component, which are directly electrically connected by means of the conductive track, are bonded. As an alternative to this, the bonding of the two electrical components and/the formation of the conductive track only takes place after the opening has been created. The method expediently provides that at least the base body, with the continuous, electrically conductive antenna surface bonded to it, as well as the communications receiver bonded to it, which is electrically connected to the antenna surface at two different feed points, preferably by means of data lines, is made available before excitation of the antenna surface.

The maximum and the minimum of the current distribution are, for example, determined. If a plurality of maxima or minima are present here, all of each of these are expediently determined. The opening is, for example, introduced between the maximum and the minimum, or at least between one of the maxima and one of the minima. Particularly preferably, however, the antenna surface is opened at the maximum. If a plurality of (local) maxima is present, the antenna surface is expediently opened at all of these positions.

The hearing aid is, for example, an earpiece set or a headset. The hearing aid is particularly preferably a hearing aid device that serves to supply someone in need of assistance. The hearing aid device is, in particular, a medical device and is, for example, a tinnitus masker, or the hearing aid device serves the for example selective amplification and/or adaptation of sound waves that are introduced into an auditory canal of a wearer of the hearing aid device. The hearing aid device is suitable for this purpose, in particular configured for it. The hearing aid device is, for example, a “behind-the-ear” hearing aid device, or an “in-the-ear” hearing aid device, such as an ITC or CIC hearing aid device.

The hearing aid contains a circuit board that has a base body. A first electrical component and a second electrical component are bonded to the base body, and are electrically interconnected by a conductive track. An electrically conductive, continuous antenna surface and a communications receiver are furthermore bonded to the base body. The communications receiver is connected electrically to the antenna surface at two different feed points, wherein the antenna surface is partially opened between the feed points.

The hearing aid preferably contains one or a plurality of electromechanical sound transducers. One of these in particular functions as a microphone, and the remainder as loudspeakers. A signal processor is appropriately disposed between these in terms of signal technology, by means of which a processing of signals received by means of one of the electromechanical sound transducers takes place. The signal processor is preferably of digital design, and the electromechanical sound transducer that functions as a microphone expediently contains an A/D converter. The first electrical component here is preferably the electromechanical sound transducer that functions as a microphone, and/or the signal processor corresponds to the second electrical component. The circuit board is preferably created according to a method, or at least designed according to this method, in which the antenna surface with no opening is electrically excited in the first frequency band. The antenna surface is opened depending on the resulting current distribution.

The developments and advantages described in the context of the circuit board are also to be analogously transferred to the method and the hearing aid, as well as between each other and vice versa.

Exemplary embodiments of the invention are explained in more detail below with reference to a drawing.

Other features which are considered as characteristic for the invention are set forth in the appended claims.

Although the invention is illustrated and described herein as embodied in a circuit board of a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a mobile telephone and a hearing aid with a circuit board according to the invention;

FIG. 2 is a transparent plan view of the circuit board;

FIG. 3 is a side view of the circuit board;

FIG. 4 is a bottom view of the circuit board;

FIG. 5 is a plan view of the circuit board;

FIGS. 6 and 7 each show a plan view of variants of the circuit board; and

FIG. 8 is a flow diagram of a method for manufacture of the circuit board.

### DETAILED DESCRIPTION OF THE INVENTION

Parts that correspond to one another are given the same reference signs in all the figures.

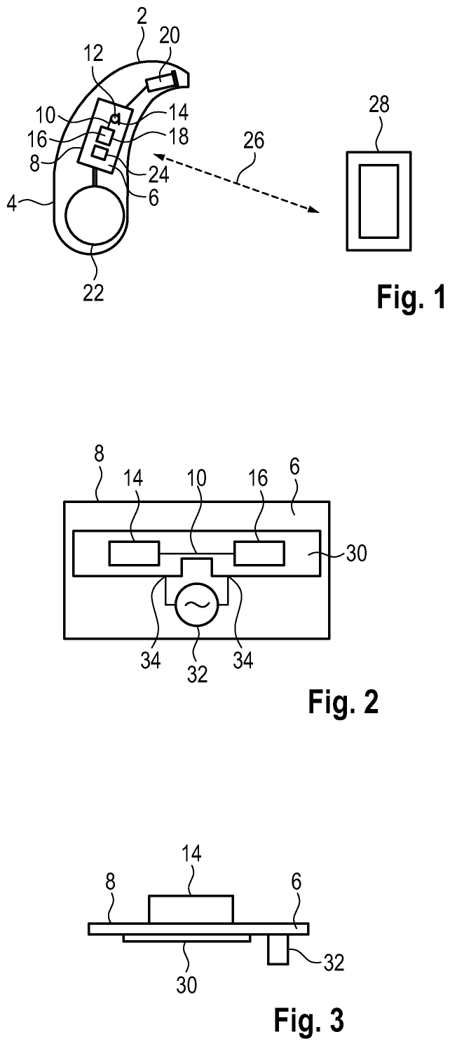

Referring now to the figures of the drawings in detail and first, particularly to FIG. 1 thereof, there is shown a hearing aid configured as a hearing aid device 2 that is provided and configured to be worn behind the ear of a user (user, hearing aid carrier, wearer). This is, in other words, a behind-the-ear hearing aid device that has a sound tube, not illustrated, that is introduced into the ear. The hearing aid device 2 contains a housing 4 that is manufactured of a plastic. A circuit board 6 is disposed inside the housing 4, and is stabilized and held by means of suitable projections bonded to the housing 4. The circuit board 6 has a base body 8 that is manufactured of a glass-fiber-reinforced epoxy resin. A plurality of conductive tracks 10 are arranged at the epoxy resin, and partially embedded in it. The conductive tracks 10 are created from copper by means of etching.

An electromechanical sound transducer 12 that functions as a microphone and has an A/D converter, not illustrated in more detail, is bonded to the base body 8. The electromechanical sound transducer 12 forms a first electrical component 14. The first electrical component 14 is connected by means of one of the conductive tracks 10 electrically, and thereby also in terms of signal technology, to a second electrical component 16, that is configured as a signal processor 18. The signal processor 18 is a digital signal processor (DSP). When operating, an audio signal recorded by the electromechanical sound transducer 12 that is serving as a microphone is processed by the signal processor 18, wherein particular frequencies are amplified, and others attenuated. A compression level is also set. The audio signals processed in this way are then fed to an amplifier circuit, not shown in more detail.

A further electromechanical sound transducer 20 that serves as a loudspeaker is coupled in terms of signal technology to the circuit board 6, by means of which the audio signal that has been amplified by means of the amplifier circuit and processed is output as a sound signal. These sound signals are guided by means of the sound tube, not illustrated in more detail, into the ear of a user of the hearing aid 2. Electricity is supplied to the circuit board 6 and to the components arranged thereon, to the electromechanical sound transducer 20 and the further components of the hearing aid device 2, by means of a battery 22.

The hearing aid device 2 further contains a communications apparatus 24 that is bonded to the base body 8 and is thus an element of the circuit board 6. A wireless radio communication 26 with a mobile telephone 28 takes place by means of the communications apparatus 24. The mobile telephone 28 contains a corresponding communications apparatus/radio equipment for this purpose. An exchange of data between the hearing aid device 2 and the mobile telephone 28 configured as a smartphone is thus enabled. The radio communication 26 operates here according to a Bluetooth standard.

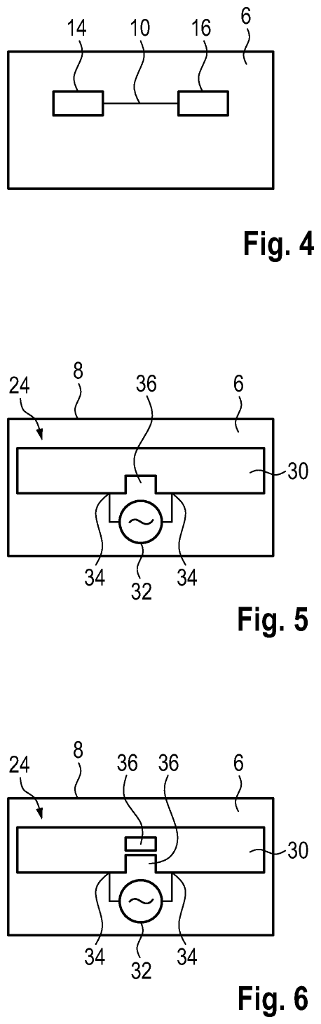

A transparent plan view of the circuit board 6 is shown in FIG. 2, which in this example contains an essentially rectangular, plate-shaped base body 8. A side view of the circuit board 6 is shown in FIG. 3, a view from underneath in FIG. 4, and a plan view in FIG. 5. As can be seen in FIG. 4, the first electrical component 14 and the second electrical component 16 are bonded to the underneath of the circuit board, and are electrically contacted with one another by means of one of the conductive tracks 10. The two electrical components 14, 16, are fastened to the base body 6 by means of an SMD method, in which the conductive tracks 10 are created from a copper layer by means of etching. The two electrical components 14, 16 are electrically connected directly by means of the conductive tracks 10. In other words, no further electrical or electronic component is introduced between them or in the conductive track 10. In summary, a low-resistance connection between the two electrical components 14, 16 is established by means of the conductive track 10.

The communications apparatus 24, which contains a continuous, electrically conductive antenna surface 30, is arranged on the opposite side of the base body 8, which thus means on the upper side. The antenna surface 30 here covers a comparatively large region of the base body 8, and extends over the projection of the two electrical components 14, 16 as well as the conductive tracks 10. The antenna surface 30 is also created from copper by means of etching. When the base body 8 is manufactured, the conductive tracks 10 and the antenna surface 30 are manufactured in the same working step and in the same manner, wherein they are each detached from a copper layer that is fastened to the glass-fiber-reinforced epoxy resin. Different layers of copper are used here to manufacture the antenna surface 30 and the conductive tracks 10.

A communications receiver 32, which is thus a transceiver, is located on the same side of the base body 8 as the antenna surface 30. The communications receiver 32 is suitable, in particular provided and configured, to excite the antenna surface 30 electrically, and to acquire and evaluate an electrical excitation of the antenna surface 30. The communications receiver 32 is electrically contacted with the antenna surface 30 for this purpose at two different feed points 34. More of the conductive tracks 10 are in particular used for this purpose. The communications receiver 32 is also fastened to the base body 8 by means of SMD technology, makes electrical contact with it, and is thus also electrically contacted with the conductive tracks 10 that provide feed points 42. The communications receiver 32 is electrically connected to the second component 16 by means of a through-contact, not illustrated in more detail.

The antenna surface 30 is spatially opened between the two feed points 34. The antenna surface 30 here has a reduction in its depth that is provided here by means of the opening 36. The opening 36 is thus introduced into the edge of the antenna surface 30, and consequently has an open configuration. If the opening 36 were not present, the antenna surface 30 would be essentially rectangular. The opening 36 is located essentially centrally along the longitudinal direction of the antenna surface 30, i.e. along its longer extent. The opening 36 is itself also rectangular, so that the form of the antenna surface is now essentially U-shaped. All the sections of the antenna surface 30 are provided by means of a common metal surface, so that all the sections of the antenna surface 30 have a low-resistance connection to one another.

The characteristic impedance of the antenna surface 30 is modified as a result of the openings 36. The characteristic impedance of the antenna surface 30 is adjusted here to the impedance of the communications receiver 32, and these are precisely the same. No additional components such as inductors are thus necessary in the data lines by means of which the feed points 42 are connected to the communications receiver 32. Materials costs and space requirement are thus reduced, while there is no loss in the quality of the excitation of the antenna surface 30 by means of the communications receiver 32. Since the antenna surface 30 and the conductive track 10 are disposed on opposite sides of the base body 6, this has an at least partially attenuating effect, which reduces an interaction between these elements. In a further alternative, the antenna surface 30 is located on all layers of the circuit board 6.

A variation of the circuit board 6 is shown in FIG. 6, in which essentially only the antenna surface 30 is modified. There are now two openings 36 located spatially between the feed points 34. One of the openings 36 is again introduced into the edge of the antenna surface 30, so that this opening 36 is open. The further opening 36 is introduced into a central region of the antenna surface 30, so that this is closed and takes the form of a hole.

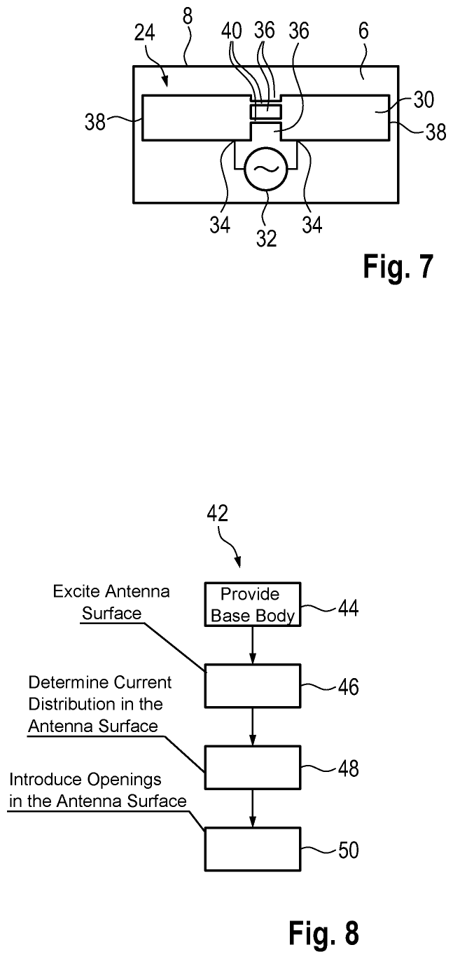

A further form of embodiment of the antenna surface 30 is shown in FIG. 7, in which there is another additional opening 36, located at the edge of the antenna surface 30 that is opposite to the feed points 34. The antenna surfaces now comprise two essentially rectangular sections 38 that are connected with low resistance by means of two bridges 40. The sections 38 and the bridges 40 are here molded onto one another, and are thus one piece.

Due to the additional openings 36 of the forms of embodiment shown in FIGS. 6 and 7, the characteristic impedance of the antenna surface 30 is further changed, so that a different communications receiver 32 can be used. In those forms of embodiment the communications apparatus 24 is again formed by means of the antenna surface 30 and the communications receiver 32.

In all of the forms of embodiment of the circuit board 6 shown above, the antenna surface 30 and the communications receiver 32 are configured for transmitting and receiving electromagnetic waves in a first frequency band, so that the radio communication 24 is enabled, wherein the far field in particular is used. The first frequency band is between 2.4 GHz and 2.5 GHz, so that the Bluetooth standard is satisfied. The first electrical component 14 and the second electrical component 16 are configured for the exchange of electrical signals via the conductive track 10 in a second frequency band. The second frequency band here is between 10 MHz and 50 MHz. The first and the second frequency bands thus differ. As a result of the different frequency bands, an interaction, and consequently a feedback, between the electrical signals exchanged with the conductive track 10 and the electromagnetic waves radiated by means of the antenna surface 30 is prevented, as a result of which reliable operation is enabled.

The feed points 34, for example, are located directly at the edges of the openings 36. As an alternative to this, the feed points 34 are displaced with respect to the edges of the opening 36. The development of resonant oscillations is improved in this way. As a result of the openings 36 and the selection of the width of the continuous electrical connection of the antenna surface 30, the use of isolating inductors in the conductive track 10 of the antenna surface 30 and/or data lines is not necessary.

A method 42 for the manufacture of the circuit board 6 is illustrated in FIG. 8. In a first working step 44, the base body 8 is provided, to which the two electrical components 14, 16, which are connected to one another by means of the conductive track 10, are already bonded. The base body 6 is also already bonded to the communications receiver 32, which is electrically connected via the feed points 34 to the antenna surface 30. No opening has yet been made in the antenna surface 30, which thus does not yet have an opening 36. Rather the antenna surface 30 is still rectangular.

In a subsequent, second working step 46, the antenna surface 30 is electrically excited in the first frequency band. An alternating electrical voltage is hereby applied by means of the communications receiver 32 via the feed points 34 to the antenna surface 30, wherein the frequency of the alternating voltage is varied in the first frequency band between 2 GHz and 3 GHz. In a subsequent third working step 48 the current distribution resulting in the antenna surface 30 as a result of the applied electrical voltage is determined. In other words, the points of the antenna surface 30 where a maximum of the electrical current flow results, i.e. where, in particular, excessively high electrical charge collects, are determined.

In a subsequent fourth working step 50, the opening 36, or the plurality of openings 36, is introduced into the antenna surface 30. The openings 36 are here positioned at the maximum of the current distribution. The antenna surface 30 is thus opened at the maximum of the current distribution, and the opening is made depending on the current distribution resulting from the electrical excitation. As a result of the opening 36, the characteristic impedance of the antenna surface 30 is changed, and is matched to the impedance of the communications receiver 32.

The first to the third working steps 44-48 are in particular at least partially carried out by means of software. It is also possible to carry out the method 42 a plurality of times in sequence, wherein the fourth working step 50 is also carried out by means of software. An actual creation of the openings 36 in the antenna surface 30 only takes place on the last pass through the method 42. In summary, in the method 42 a characteristic mode analysis is carried out of the entire antenna surface 30 which does not yet have an opening 36 by means of numerical field simulation. In the third working step 48, the current distribution of the modes is determined, and those modes that should be excited when the hearing aid 2 is operating, i.e. in particular of the first frequency band, are selected. The opening 36, or the multiple openings 36, are then positioned in such a way that the selected modes are efficiently excited and, at the same time, the input impedance of the antenna surface 30 is matched to the communications receiver 32. The opening 36 is in particular positioned for this purpose in the current maximum of the selected mode. After this, the antenna surface 30 can be excited by the communications receiver 32 at the edges of the opening 36, and both the excitation and the antenna characteristic, i.e. the characteristic of the antenna surface 30, are measured. If required by the specifications of the hearing aid 2, the positioning of the opening 36, as well as the subsequent excitation of the antenna surface 30 by means of the communications receiver 32, and also the measurement of the matching and of the antenna characteristic, are repeated multiple times, wherein expediently an additional opening 36 is employed each time, so that the number of openings 36 is increased. As an alternative, the existing opening 36 is changed.

In summary, one or a plurality of openings 36 are thus introduced into the antenna surface 30, while the communications receiver 32, i.e. the RF transceiver, makes contact with this at opposite edges of the antenna surface 30 via the feed points 34. No high impedance is thus present between the electrically conductive regions of the antenna surface 30 in the first frequency band. A filter of electromagnetic waves is therefore not necessary in the operation of the two electrical components 14, 16.

A characteristic mode analysis is, for example, carried out in order to ascertain the resonant frequency of the antenna surface 30. The opening 36, or the openings 36, are subsequently inserted in the antenna surface 30 where the current distribution of the mode or modes reaches a maximum. In a further embodiment, the opening 36 is introduced at a position that is located between the maximum and the minimum.

The communications receiver 32 is connected to the antenna surface 30 via the feed points 34 at opposing sides of the opening 36, in particular in the region of the edges. The individual electrically conductive regions of the antenna surface 30 are not electrically separated by the opening 36. All of the electrically conductive regions of the antenna surface 30 are thus electrically connected, and the connection is in particular made with low resistance. As a result of the opening 36, a high impedance is not necessary for an electrical excitation in the first frequency band, and therefore no additional electrical components are needed. Materials costs are thus reduced.

The invention is not restricted to the exemplary embodiments described above. Rather other variants of the invention can be derived from them by the expert, without going beyond the object of the invention. In particular, furthermore, all the individual features described in connection with the individual exemplary embodiments can also be combined with one another in other ways without going beyond the object of the invention.

The following is a summary list of reference numerals and the corresponding structure used in the above description of the invention:

2 Hearing aid device

### 4 Housing

6 Circuit board
8 Base body
10 Conductive track
12 Electromechanical sound transducer
14 First electrical component
16 Second electrical component
18 Signal processor
20 Electromechanical sound transducer

### 22 Battery

24 Communications apparatus
26 Radio communication
28 Mobile telephone
30 Antenna surface
32 Communications receiver
34 Feed point

### 36 Opening

### 38 Section

### 40 Bridge

### 42 Method

44 First working step
46 Second working step
48 Third working step
50 Fourth working step

1. A circuit board of a hearing aid, the circuit board comprising:
a first electrical component;
a second electrical component;
a base body having a conductive track, said first electrical component and said second electrical component directly electrically connected by means of said conductive track;
an electrically conductive, continuous antenna surface disposed on said base body; and
a communications receiver connected electrically at two different feed points to said electrically conductive, continuous antenna surface, wherein said electrically conductive, continuous antenna surface is partially opened between said two different feed points.

2. The circuit board according to claim 1, wherein said electrically conductive, continuous antenna surface and said conductive track are disposed on opposite sides of said base body.

3. The circuit board according to claim 1, wherein said first electrical component is an electromechanical sound transducer, and said second electrical component is a digital signal processor.

4. The circuit board according to claim 1, wherein:
said electrically conductive, continuous antenna surface and said communications receiver are configured for transmitting and receiving electromagnetic waves in a first frequency band; and
said first electrical component and said second electrical component are configured for an exchange of electrical signals in a second frequency band, wherein the first and the second frequency bands are different.

5. A method for manufacturing a circuit board, which comprises the steps of:
providing a base body having a conductive track, a first electrical component and a second electrical component directly electrically connected by means of the conductive track;
providing an electrically conductive, continuous antenna surface disposed on the base body;
connecting a communications receiver electrically at two different feed points to the electrically conductive, continuous antenna surface, wherein the electrically conductive, continuous antenna surface is partially opened between the two different feed points, the electrically conductive, continuous antenna surface and the communications receiver are configured for transmitting and receiving electromagnetic waves in a first frequency band, and the first electrical component and the second electrical component are configured for an exchange of electrical signals in a second frequency band, wherein the first and the second frequency bands are different;
electrically exciting the electrically conductive, continuous antenna surface in the first frequency band; and
opening the electrically conductive, continuous antenna surface to adjust a characteristic impedance depending on a resulting current distribution.

6. The method according to claim 5, which further comprises determining a maximum of a current distribution in the electrically conductive, continuous antenna surface, and that the electrically conductive, continuous antenna surface is opened there.

7. A hearing aid, comprising:
a circuit board, containing:
a first electrical component;
a second electrical component;
a base body having a conductive track, said first electrical component and said second electrical component directly electrically connected by means of said conductive track;
an electrically conductive, continuous antenna surface disposed on said base body; and
a communications receiver connected electrically at two different feed points to said electrically conductive, continuous antenna surface, wherein said electrically conductive, continuous antenna surface is partially opened between said two different feed points.
